(19) United States
(12) Patent Application Publication
(10) Pub. No.: US 2025/0262939 A1
(43) Pub. Date: Aug. 21, 2025

(54) CONTENT OUTPUT DEVICE AND CONTENT OUTPUT METHOD

(71) Applicant: HONDA MOTOR CO., LTD., Tokyo (JP)

(72) Inventor: Masashi Akachi, Tokyo (JP)

(21) Appl. No.: 19/012,346

(22) Filed: Jan. 7, 2025

(30) Foreign Application Priority Data
Feb. 15, 2024 (JP) 2024-021417

(51) Int. Cl. B60K 35/65; B60K 35/28

(52) U.S. Cl. CPC B60K 35/656; B60K 35/28; B60K 2360/731; B60K 2360/741

(57) ABSTRACT

A content output device includes a display controller for controlling output of a content to a display device provided for each of seats of a moving object, and an identification unit for identifying each of occupants seated in the seats of the moving object, and the display controller is adapted to: in accordance with a content output instruction from one occupant seated in one seat, connect to an account of the one occupant, the account being related to content viewing, and output a content to be provided to the account to one display device that is the display device for the one seat; and stop the output of the content to the display device for the one seat while maintaining the connection to the account when the one occupant leaves the one seat.

### INCORPORATION BY REFERENCE

The present application claims priority under 35 U.S.C. § 119 to Japanese Patent Application No. 2024-021417 filed on Feb. 15, 2024. The content of the application is incorporated herein by reference in its entirety.

### BACKGROUND OF THE INVENTION

### Field of the Invention

The present invention relates to a content output device and a content output method.

### Description of the Related Art

In recent years, research and development for obtaining data on a seating position of a user and giving assistance to the user have been conducted.

Japanese Patent Laid-Open No. 2022-84358 describes a seating position determination system that can identify the seating position of each user who gets into a vehicle. This system determines the seating position of the user by detecting a user's smart key when a door is opened and searching for the smart key after the door is closed. This system also stores vehicle settings such as HMI settings for the user, and automatically sets the vehicle settings to user's preferences when the user sits down.

When a content is displayed using an account of a user by a display device arranged for each seat in a vehicle, the user may need to perform operations such as turning the content display on and off when the user leaves the seat to get off the vehicle, change seating position (change the seat), etc. such that other users do not view the content. Such operations may be necessary even when the user leaves the seat temporarily or the like, which may be bothersome for the user.

In order to solve the above problem, the present application has an object to improve the convenience of user operations when a content to be provided to a user's account is output on a moving object, thereby further improving traffic safety and contributing to the development of a sustainable transportation system.

### SUMMARY OF THE INVENTION

An aspect of the present invention is a content output device including a display controller for controlling output of a content to a display device provided for each of seats of a moving object, and an identification unit for identifying each of occupants seated in the seats of the moving object, wherein the display controller is adapted to, in accordance with a content output instruction from one occupant seated in one seat, connect to an account of the one occupant, the account being related to content viewing, and output a content to be provided to the account to one display device that is the display device for the one seat, and stop the output of the content to the display device for the one seat while maintaining the connection to the account when the one occupant leaves the one seat.

According to another aspect of the present invention, the display controller releases the connection to the account of the one occupant when a predetermined standby time has elapsed after the output of the content to the display device for the one seat is stopped.

According to another aspect of the present invention, the moving object is a vehicle, and the standby time is determined based on a location where the moving object is stopped when the one occupant leaves the one seat.

According to another aspect of the present invention, when seating of an occupant in the moving object is detected during the standby time after the output of the content to the display device for the one seat is stopped, the display controller determines whether the one occupant is seated in the moving object, and when the one occupant is seated in the moving object, the display controller resumes the output of the content which has been stopped to a display device for a seat in which the one occupant is seated.

According to another aspect of the present invention, when seating of an occupant in the moving object is detected during the standby time after the output of the content to the display device for the one seat is stopped, the display controller determines whether the one occupant is seated in the moving object, and when the one occupant is not seated in the moving object, the display controller maintains an output stop state of the content.

According to another aspect of the present invention, when the moving object is fully occupied during the standby time after the output of the content to the display device for the one seat is stopped, the display controller determines whether the one occupant is present in the moving object, and when the one occupant is not present in the moving object, the display controller releases connection to the account of the one occupant.

According to another aspect of the present invention, the display controller shortens the standby time when a switch of a drive device of the moving object is turned off during the standby time after the output of the content to the display device for the one seat is stopped.

Another aspect of the present invention is a content output method to be executed by a computer of a content output device for outputting a content to a display device provided for each of seats of a moving object, and includes a display control step of controlling output of a content to the display device provided for each of the seats, and an identification step of identifying each of occupants seated in the seats of the moving object, wherein the display control step includes: in accordance with a content output instruction from one occupant seated in one seat, connecting an account of the one occupant, the account being related to content viewing, and outputting a content to be provided to the account to one display device that is the display device for the one seat; and stopping the output of the content to the display device for the one seat while maintaining the connection to the account when the one occupant leaves the one seat.

According to the aspects of the present invention, it is possible to improve the convenience of user operations when a content to be provided to a user's account is output on a moving object.

### BRIEF DESCRIPTION OF THE DRAWINGS

FIG. 1 is a diagram showing an example of a scene in which a content output device according to an embodiment of the present invention is used;

FIG. 2 is a diagram showing an example of the configuration of a vehicle in which the content output device is installed;

FIG. 3 is a diagram showing the configuration of the content output device;

FIG. 4 is a flow diagram showing a procedure of operations of the content output device;

FIG. 5 is a flow diagram showing the procedure of the operations of the content output device;

FIG. 6 is a diagram showing suspension of content output which is caused when an occupant leaves his/her seat; and

FIG. 7 is a diagram showing a change of content output which is caused when the occupant moves.

### DETAILED DESCRIPTION OF THE PREFERRED EMBODIMENT

### 1. Embodiment

An embodiment according to the present invention will be described hereunder with reference to the drawings.

### 1.1 Overall Outline

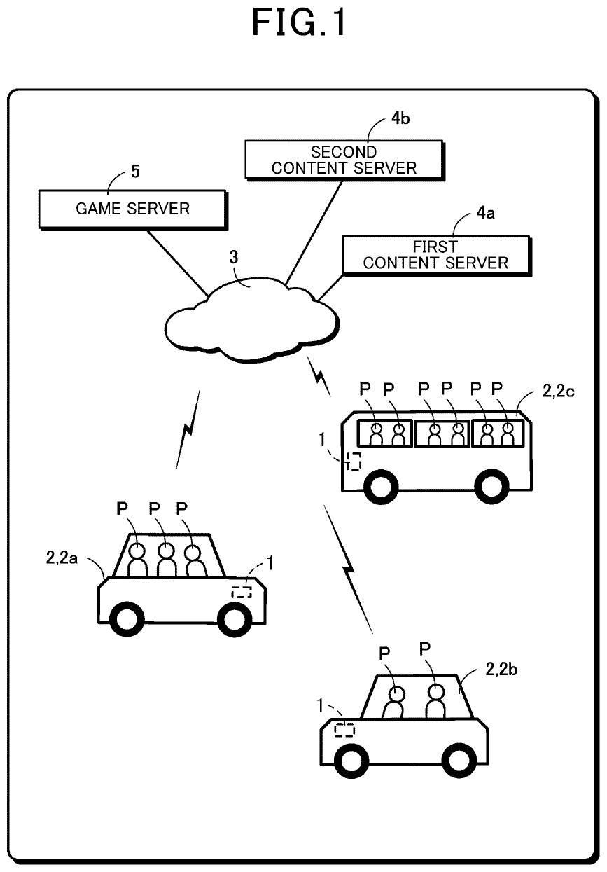

FIG. 1 shows an example of a scene in which a content output device 1 according to an embodiment of the present invention is used. The content output device 1 is installed in a moving object 2 in which a plurality of persons ride together as occupants P. In the example shown in FIG. 1, a passenger car 2a with three rows of seats, a passenger car 2b with two rows of seats, and a bus 2c are shown as examples of the moving object 2. However, these are only examples, and the moving object 2 can be any vehicle (for example, a shared car, a taxi, a public bus, or the like) in which a plurality of persons can ride.

Furthermore, the moving object 2 is not limited to a vehicle, and may be any moving object in which a plurality of persons can ride. Such moving objects may be land moving objects such as a passenger car, a bus, a tax, and a train, marine moving objects such as a ship and a submarine, aerial moving objects such as an aircraft including an electric vertical take-Off and landing aircraft (eVTOL) and an airship, or space moving objects such as a spacecraft and an artificial satellite.

The content output device 1 outputs contents provided by a server device equipped outside the moving object 2, contents stored in a storage device equipped in the moving object 2, etc. inside the interior (cabin) of the moving object 2, for example, in accordance with an instruction from an occupant P of the moving object 2. In the present embodiment, the contents means any information that the user can view via an audiovisual device, such as movies, animations, dramas, games, etc.

FIG. 1 shows a first content server 4a, a second content server 4b, and a game server 5 as examples of server devices for providing contents. The content output device 1 is communicably connected to the first content server 4a, the second content server 4b, and the game server 5 via a communication network 3. The communication network 3 is, for example, the Internet.

The first content server 4a and the second content server 4b are used for different content viewing services to be provided by different content providers, respectively. For example, the content viewing services may be Netflix, Amazon Prime, Hulu, etc. Hereinafter, the first content server 4a and the second content server 4b are collectively referred to as content servers 4.

In the present embodiment, for example, a user can view contents to be provided by each of the first content server 4a and the second content server 4b by obtaining an account for the corresponding content viewing service in advance and subscribing to the content viewing service.

The game server 5 is a server device that provides contents of games (hereinafter also referred to as game contents), and it is operated, for example, by a company that provides a game content providing service. For example, a user can enjoy an online game by accessing the game server 5. In the present embodiment, the user is allowed to use the game contents provided from the game server 5 (play games) by obtaining an account for the corresponding game content supply service in advance and subscribing to the game providing service. In the present embodiment, viewing contents also includes using game contents. This is because when using a game content, a user views video and audio of the game content.

Hereinafter, services for providing contents that include content viewing services and game content providing services are collectively referred to as content providing services.

Each of companies that provide content providing services by using each of the first content server 4a, the second content server 4b and the game server 5 sets up, on a communication network 3, a website on which users use these services. A user logs in to a website of each service by using an account that the user has obtained for that service, which allows the user to view a content provided by each service.

The contents provided by the first content server 4a, the second content server 4b, and the game server 5 are prohibited from being viewed by anyone other than users who have acquired accounts (hereinafter also referred to as account users) in accordance with the terms of the corresponding services.

Furthermore, the content output device 1 may communicate with a content server or a game server (both not shown) via the communication network 3, the content server or the game server being usable without obtaining an account, and output contents provided by these server devices inside the cabin of the moving object 2.

The number of content servers and/or game servers that are connected to the communication network 3 and can be used by the content output device 1 is arbitrary.

### 1.2 Configuration of Vehicle

Next, the configuration of the moving object 2 in which the content output device 1 is installed will be described.

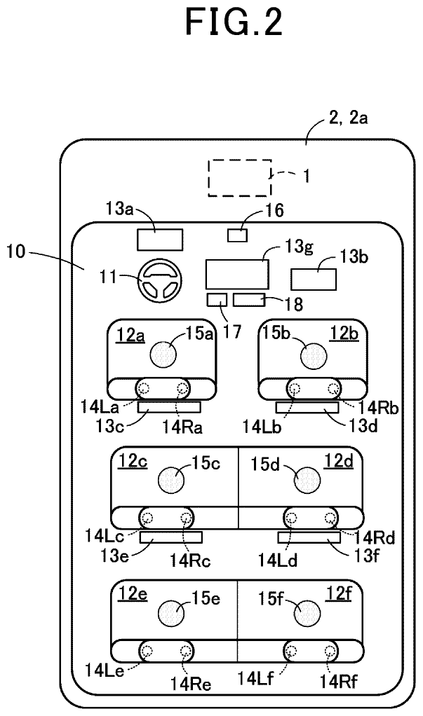

FIG. 2 is a diagram showing an example of the configuration of the moving object 2. FIG. 2 shows the configuration of the passenger car 2a with three rows of seats as an example of the moving object 2, but other moving objects such as the passenger car 2b and the bus 2c can also be configured in a similar manner.

A driver's seat 12a in which a driver operating a steering wheel 11 is seated, an assistant driver's seat 12b, a second-row left seat 12c, a second-row right seat 12d, a third-row left seat 12e, and a third-row right seat 12f are arranged in a cabin 10 in which occupants P of the moving object 2 are seated. Hereinafter, the driver's seat 12a, the assistant driver's seat 12b, the second-row left seat 12c, the second-row right seat 12d, the third-row left seat 12e, and the third-row right seat 12f are collectively referred to as seats 12.

A display device is provided in front of each of the seats 12 of the moving object 2 to allow the occupant P seated in the seat 12 to view a content.

For example, a display device 13a that can be seen by the driver, i.e., the occupant P seated in the driver's seat 12a, is arranged on an instrument panel (not shown) of the moving object 2 in front of the driver's seat 12a. Furthermore, a display device 13b that can be seen by the occupant P seated in the assistant driver's seat 12b is arranged on the instrument panel in front of the assistant driver's seat 12b.

Furthermore, display devices 13c and 13d that can be seen by occupants P seated in the second-row left seat 12c and the second-row right seat 12d respectively are arranged on the rear surfaces (surfaces facing the rear of the moving object 2) of the backrests of the driver's seat 12a and the assistant driver's seat 12b in front of the second-row left seat 12c and the second-row right seat 12d, respectively. Similarly, display devices 13e and 13f that can be seen by occupants P seated in the third-row left seat 12e and the third-row right seat 12f are arranged on the rear surfaces of the backrests of the second-row left seat 12c and the second-row right seat 12d in front of the third-row left seat 12e and the third-row right seat 12f, respectively.

Furthermore, a display device 13g, which is a central display device that can be seen by all occupants P seated in any of the seats 12, is arranged in the center of the instrument panel of the moving object 2.

Hereinafter, the display devices 13a, 13b, 13c, 13d, 13e, 13f, and 13g are collectively referred to as display devices 13.

In the present specification, “the display device 13 provided to the seat 12” and “the display device 13 of the seat 12” are the display devices 13 that are provided in front of the respective seats 12 of the moving object 2 and used for the occupants P seated in the seats 12 to view.

In the present embodiment, the display device 13 is a touch panel that has both a display function and a function for inputting an operation by a user. However, the display device 13 is not limited to the touch panel, and may be any type of display device. If the display device 13 does not have any operation inputting function, each seat 12 may be provided with an input device to be operated by an occupant P seated in the seat 12 in addition to the display device 13. The input device may be, for example, a keyboard, a keypad, a controller for games, or the like.

Furthermore, it is not necessary that all of the display devices 13a, 13b, 13c, 13d, 13e, 13f, and 13g are of the same type, and different types of display devices may be mixed. For example, the display device 13a may be a head-up display (HUD) instead of a touch panel.

Speakers 14La and 14Ra, 14Lb and 14Rb, 14Lc and 14Rc, 14Ld and 14Rd, 14Le and 14Re, and 14Lf and 14Rf are arranged inside headrests at the upper portions of backrests of the driver's seat 12a, assistant driver's seat 12b, second-row left seat 12c, second-row right seat 12d, third-row left seat 12e, and third-row right seat 12f.

Hereinafter, speakers 14La, 14Lb, 14Lc, 14Ld, 14Le, and 14Lf are collectively referred to as speakers 14L, and speakers 14Ra, 14Rb, 14Rc, 14Rd, 14Re, and 14Rf are collectively referred to as speakers 14R. Furthermore, in the following description, the speakers 14R and 14L are collectively referred to as speakers 14.

The speakers 14L and 14R function as left speakers and right speakers for outputting stereophonic sounds to the occupants P seated in the corresponding seats 12, respectively.

Seating sensors 15a, 15b, 15c, 15d, 15e, and 15f that respectively detect the occupants P sitting in the respective seats 12 are provided under the seat surfaces of the driver's seat 12a, the assistant driver's seat 12b, the second-row left seat 12c, the second-row right seat 12d, the third-row left seat 12e, and the third-row right seat 12f. Hereinafter, the seating sensors 15a, 15b, 15c, 15d, 15e, and 15f are collectively referred to as seating sensors 15.

Furthermore, in the cabin 10 of the moving object 2, an interior camera 16 is provided at a position where the interior camera can image the occupant P seated in each of the driver's seat 12a, the assistant driver's seat 12b, the second-row left seat 12c, the second-row right seat 12d, the third-row left seat 12e, and the third-row right seat 12f. The interior camera 16 is disposed, for example, above the windshield (not shown) of the moving object 2 (i.e., at a position close to the ceiling of the cabin 10).

The moving object 2 may also be provided with a media reader 17 on the instrument panel, the media reader 17 serving as a device for reading storage media and being located at a position below the display device 13g which is the central display device. The media reader 17 may include not only a device for reading semiconductor memories such as a USB memory (registered trademark) and an SD memory card (registered trademark), but also a CD/DVD drive which is a device for reading storage media such as CD and DVD.

The moving object 2 also includes a vehicle control device 18 having a processor for controlling the traveling of the moving object 2 which is a vehicle, and a navigation device 19. The vehicle control device 18 detects on/off of a switch SW of a drive device M equipped in the moving object 2 and the moving speed of the moving object 2 to control the drive device M. The navigation device 19 includes a processor that receives GNSS radio waves according to a conventional technique, identifies the current travel location and/or stop location of the moving object 2 from the position coordinates of the current position of the moving object 2 and map information, and provides guidance on a moving route of the moving object 2 to a destination.

### 1.3 Configuration of Content Output Device

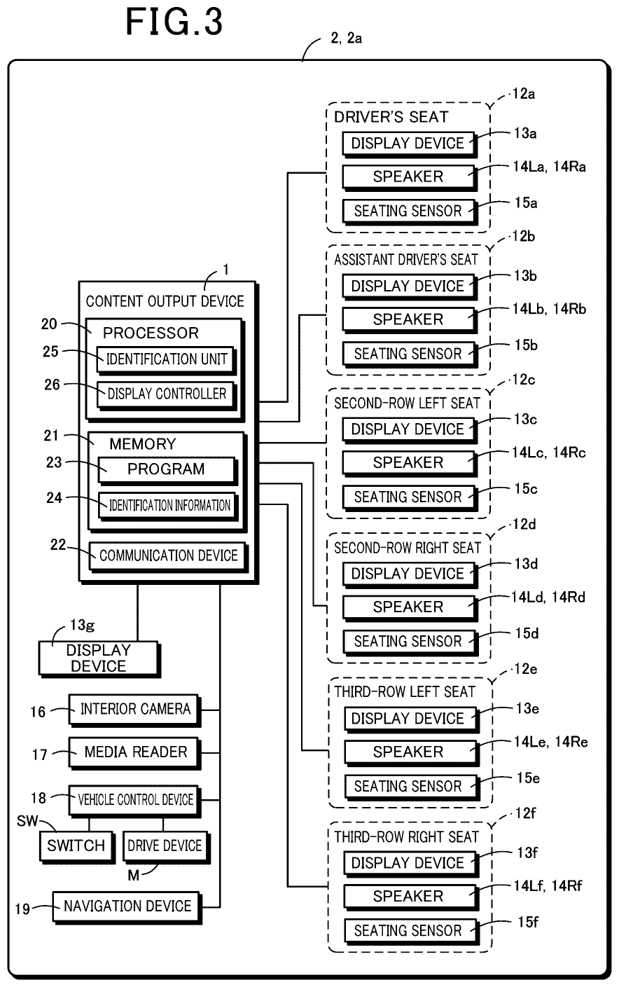

FIG. 3 is a diagram showing a configuration of the content output device 1 installed in the moving object 2.

The content output device 1 includes a processor 20, a memory 21, and a communication device 22. The memory 21 is configured, for example, by a volatile and/or non-volatile semiconductor memory and/or a hard disk device or the like.

The communication device 22 is a transceiver with which the content output device 1 wirelessly communicates with external devices (including the content server 4 and the game server 5) via the communication network 3.

The processor 20 is, for example, a computer equipped with a central processing unit (CPU) and the like. The processor 20 may also be configured to have a read only memory (ROM) in which a program is written, a random access memory (RAM) for temporary storing data, and the like. The processor 20 includes an identification unit 25 and a display controller 26 as functional elements or functional units.

These functional elements of the processor 20 are implemented, for example, by executing a program 23 stored in the memory 21 through the processor 20 which is a computer. The program 23 may be stored in any computer-readable storage medium. Alternatively, all or some of the functional elements of the processor 20 may be configured by hardware each including one or more electronic circuit components.

The identification unit 25 identifies the respective occupants P seated in the seats 12 of the moving object 2. When a person gets in the moving object 2 and becomes an occupant P, the identification unit 25 stores unique information of the occupant P such as a facial image into the memory 21 as identification information 24 for identifying the occupant P.

Specifically, for example, the identification unit 25 detects that a new person has gotten in the moving object 2 and seated in one of the seats 12, based on an image of the cabin 10 captured by the interior camera 16 and seating information from the seating sensor 15 arranged in each seat 12 (information as to whether a person is seated in that seat 12). When the identification unit 25 detects that a new person has gotten in the moving object 2 and seated, the identification unit 25 acquires a facial image of the person from the image and sensor output, and identifies the seat 12 in which the person has been seated. The identification unit 25 stores information associating the acquired facial image with the seating information indicating the identified seat 12 as new identification information 24 of the occupant P in the memory 21.

“The seating information indicating the seat 12” may be, for example, a seat number which is associated with each of the seats 12 in advance. The identification unit 25 may assign an occupant P an occupant ID which is a temporary ID, and include the occupant ID of the corresponding occupant P in the identification information 24. Note that FIG. 2 shows one block of identification information 24 in the memory 21, but the memory 21 actually stores the same number of pieces of identification information 24 as the number of occupants P.

Furthermore, based on an image of the interior of the cabin 10 acquired by the interior camera 16 and seating information from the seating sensor 15, the identification unit 25 detects that any occupant P has left his/her seat 12 in the cabin 10. When the identification unit 25 detects that any occupant P has left his/her seat 12, the identification unit 25 notifies the display controller 26 of this fact and information indicating the seat 12 that the occupant P has left.

When the identification unit 25 detects that any occupant P has left his/her seat, the identification unit 25 identifies the occupant P who has left his/her seat based on the identification information 24 of each occupant P stored in the memory 21 (for example, the identification unit 25 identifies the occupant ID of the occupant P who has left his/her seat).

The identification unit 25 traces (or tracks) the movement of the occupant P who has left his/her seat from the image of the interior of the cabin 10 acquired by the interior camera 16, and determines whether the occupant P has gotten off the moving object 2. When the occupant P has gotten off, the identification unit 25 notifies this fact to the display controller 26, and deletes the seating information indicating the seat 12 associated with the facial image of the occupant P from the identification information 24 of the occupant P.

Furthermore, when the occupant P who left his/her seat sits down after leaving his/her seat (including a case where the occupant P who has gotten off returns to the moving object 2 and sits down), the identification unit 25 identifies the seat 12 on which the occupant P has sat. The identification unit 25 updates the identification information 24 of the occupant P stored in the memory 21 with seating information indicating the seat 12 on which the occupant P has sat down after leaving his/her seat. In other words, the identification unit 25 overwrites the seating information indicating the seat 12 associated with the facial image of the occupant P in the identification information 24 of the occupant P with the seating information indicating the seat 12 on which the occupant P has sat down after leaving his/her seat, thereby updating the identification information 24. Here, there may be a case where the occupant P sits down on the same seat 12 after leaving the seat 12. In this case, the seating information indicating the seat 12 associated with the facial image of the occupant P is the same before and after the update.

When any occupant P leaves his/her seat and then sits down, the identification unit 25 notifies the display controller 26 of this fact.

Furthermore, when it is detected that the moving object 2 has been fully occupied, the identification unit 25 notifies the display controller 26 of this fact. Whether the moving object 2 has been fully occupied can be determined, for example, by determining whether sensor information indicating seating of a person is output from the seating sensors 15 of all the seats 12 of the moving object 2.

The display controller 26 controls the output of a content to the display device 13 arranged for each of the seats 12 of the moving object 2.

For example, in accordance with an instruction from one occupant P seated in one seat 12, the display controller 26 connects to an account related to content viewing for the one occupant P, and outputs a content to be provided for the account to the display device 13 of the one seat 12. Here, “connects to an account related to content viewing” specifically means that the display controller 26 logs in to a content providing service by using the account.

Specifically, the display controller 26 accesses a website of the content providing service designated by the occupant P seated in the one seat 12 in accordance with an instruction input by the occupant P seated in the one seat 12 to the display device 13 which is a touch panel arranged for the one seat 12. Furthermore, the display controller 26 also acquires the account of the occupant P which is input by the occupant P to the display device 13.

The display controller 26 logs in to the content providing service in the accessed website by using the acquired account. The occupant P inputs an instruction for outputting a content desired to be viewed by the occupant P using the account into the display device 13. In accordance with the content output instruction, the display controller 26 transmits an output request for the content to the corresponding first content server 4a, second content server 4b, or game server 5.

The content providing service provides the requested content from the first content server 4a, the second content server 4b, or the game server 5 to the account of the occupant P which was used for the log-in. Specifically, the display controller 26 acquires data of the content to be provided (including video data, audio data, etc.) from the corresponding first content server 4a, second content server 4b, or game server 5. The display controller 26 uses the acquired content data to output the designated content to the display device 13 arranged for the seat 12 in which the occupant P is seated.

Hereinafter, an occupant P who sits on one seat 12 and inputs an account connection instruction by using one display device 13 arranged in the one seat 12 is also referred to as a “target user PT,” and the one seat 12 in which the target user PT is seated is also referred to as a “target seat 12T.” Furthermore, the one display device 13 arranged for the target seat is also referred to as a “target display device 13T”, and a content designated by a content output instruction from the target user is also referred to as a “target content.”

In the present embodiment, particularly, when the target user PT leaves the target seat 12T in which he/she has been seated by that time, the display controller 26 stops output of the target content to the target display device 13T while maintaining the connection to the account of the target user PT (i.e., while maintaining the log-in state to the account). As described above, it is detected by the identification unit 25 that the occupant P has left the seat 12. The display controller 26 can determine whether the occupant P who has left the seat 12 is the target user PT, for example, by determining whether the target content is being output by the display device 13 of that seat 12.

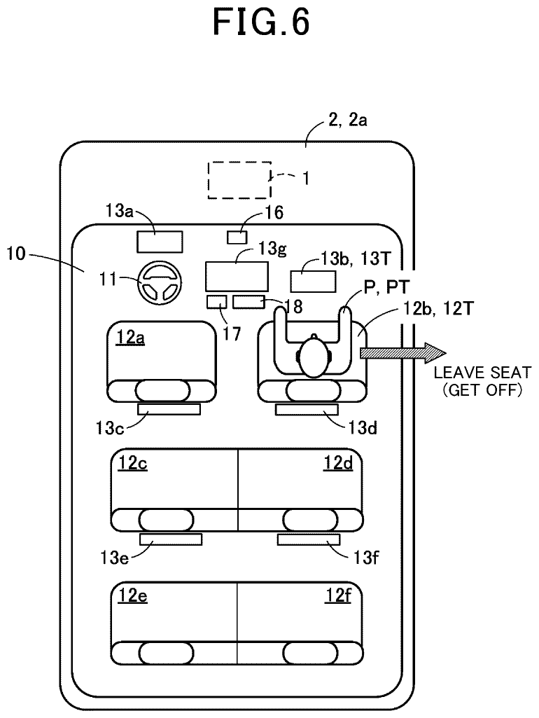

FIG. 6 is a diagram showing an example of a situation where a target user PT who is one occupant P leaves his/her seat. In the example of FIG. 6, the target user PT is seated in the assistant driver's seat 12b. Therefore, in this case, the assistant driver's seat 12b is the target seat 12T, and the display device 13b arranged for the assistant driver's seat 12b is the target display device 13T. The display control device outputs the target content to the target display device 13T while the target user PT is seated in the target seat 12T.

When the target user PT leaves the assistant driver's seat 12b corresponding to the target seat 12T in which he/she has been seated by that time, for example, for the purpose of getting off the moving object, the display controller 26 stores, in the memory 21, correspondence information for associating the account of the target user PT related to the target content with information indicating the target seat 12T, and stops the output of the target content to the target display device 13T. Here, “stops the output of the target content to the target display device 13T” specifically means that transmission of video data of the target content to the target display device 13T is stopped to cause the target content not to be displayed on the target display device 13T. At that time, the display controller 26 may, for example, hold the target content without displaying the target content on the target display device 13T in a state where an operation for the target content (for example, a video playing operation, or a video output operation for a game and a user operation acquiring operation) is temporarily suspended. Furthermore, the display controller 26 may cause a predetermined default screen to be displayed on the screen of the target display device 13T while the output of the target content is stopped.

As a result, in a case where a content (target content) to be provided to the account of the target user PT is output on the moving object 2, the output of the target content is stopped and the connection state to the account is maintained when the target user PT leaves his/her seat, so that a user's operation related to resumption of the output of the target content when the target user PT returns to his/her original seat 12 is simplified to improve convenience while others are prevented from viewing the content.

When the display controller 26 stops the output of the target content to the target display device 13T because the target user PT leaves the target seat 12T, the display controller 26 starts counting a lapse time from the stop of the output of the target content. When a predetermined standby time has elapsed since the output of the target content was stopped, the display controller 26 releases the connection to the account of the target user PT. In other words, the display controller 26 logs out the account.

As a result, when a seat-leaving time of the target user PT gets longer and exceeds the standby time, the display controller 26 releases the connection to the account, so that the target user PT does not need to return to the moving object 2 and perform an operation of releasing the connection to the account, so that convenience for the target user PT is improved.

Here, the standby time is determined based on a location where the moving object 2 is stopped when the target user PT leaves the target seat 12T. For example, when the moving object 2 is stopped at a convenience store, the standby time is set to five minutes, and when the moving object 2 is stopped at a supermarket, the standby time is set to one hour. Note that the standby time for each stop location and/or each type of stop location may be determined in advance and stored in the memory 21.

The display controller 26 can acquire, from the vehicle control device 18, information that the moving object 2 has stopped. Furthermore, the display controller 26 can also acquire information about a stop location from a navigation device 19.

The time length from a time when an occupant P gets out of the moving object 2 to a time when the occupant P gets in the moving object 2 again may generally vary according to the stop location of the moving object 2. In the above configuration, the standby time can be set according to the stop location of the moving object 2, which can further improve convenience for the user (specifically, the target user PT).

Furthermore, when seating of any occupant P in the moving object 2 (i.e., any occupant P sits on any seat 12) is detected by the identification unit 25 by a time when the standby time has elapsed since the output of the target content to the target display device 13T was stopped, the display controller 26 determines whether the target user PT is seated in the cabin 10 of the moving object 2, based on the identification information 24 stored in the memory 21 by the identification unit 25. When the target user PT is seated in the cabin 10 of the moving object 2, the display controller 26 resumes the output of the target content which has been stopped while the display device 13 of the seat 12 in which the target user PT is currently seated is set to the target display device 13T.

As a result, the target user PT who leaves his/her seat 12 can continue viewing the target content at another seat 12 on which the target user PT subsequently sits, which further improves the convenience for the target user PT.

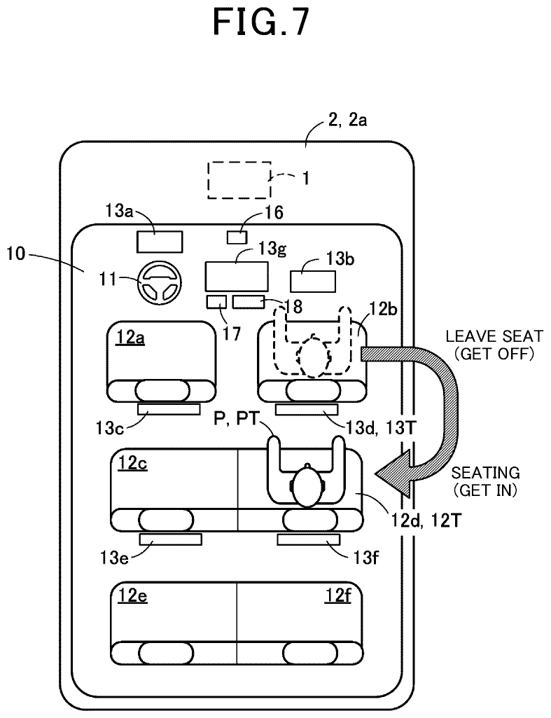

FIG. 7 shows an example in which after a target user PT who is one occupant P leaves his/her seat and gets out of the moving object 2, the target user PT sits on a seat 12 different from his/her original seat 12 when the target user PT gets in the moving object 2 again. In the example of FIG. 7, the target user PT leaves the assistant driver's seat 12b and gets out of the moving object 2. Therefore, the display controller 26 stops the output of a target content to the display device 13b for the assistant driver's seat 12b. Thereafter, the target user PT gets in the moving object 2 again and sits on the second-row right seat 12d. In this case, when the target user PT gets in the moving object 2 and sits on the second-row right seat 12d, the identification unit 25 updates the seating information included in the identification information 24 for the target user PT stored in the memory 21 with the second-row right seat 12d. Furthermore, the identification unit 25 transmits, to the display controller 26, a notification indicating that some occupant P is seated.

When receiving the notification from the identification unit 25, the display controller 26 searches through all of the identification information 24 stored in the memory 21 and finds the identification information 24 of the target user PT. This allows the display controller 26 to know that the target user PT has been seated in the cabin 10. From the seating information included in the thus-found identification information 24, the display controller 26 resumes the output of the target content which has been stopped while the display device 13d for the second-row right seat 12d in which the target user PT is currently seated is set to the target display device 13T, and.

Even when the target user PT moves from the assistant driver's seat 12b to the second-row right seat 12d without getting out of the moving object 2, the same operation as described above causes the output of the target content to be resumed on the display device 13d for the second-row right seat 12d in which the target user PT is currently seated.

Furthermore, when seating of any occupant P in the moving object 2 is detected by the identification unit 25 by a time when the standby time has elapsed since the output of the target content to the target display device 13T was stopped, the display controller 26 determines whether the target user PT has been seated in the cabin 10 of the moving object 2. When the target user PT is not seated in the cabin 10, the display controller 26 maintains the state in which the output of the target content to the target display device 13T is stopped.

As a result, even if the target user PT leaves one seat 12 and another occupant P takes that seat 12, the state in which the output of the target content is stopped is maintained, so that it is possible to appropriately prevent the other occupant P from unauthorized viewing of the target content.

Furthermore, when it is detected by the identification unit 25 that the moving object 2 has been fully occupied by the time when the standby time has elapsed since the output of the target content to the target display device 13T was stopped, the display controller 26 determines based on the identification information 24 from the identification unit 25 whether the target user PT is in the cabin 10 of the moving object 2. When the moving object 2 has been fully occupied and the target user PT is not in the cabin 10 of the moving object 2, the display controller 26 releases the connection to the account of the target user PT.

As a result, for example, when the target user PT is unlikely to get in the moving object 2 again like such a case that the moving object 2 has been fully occupied after the target user PT leaves the seat to get out of the moving object 2, the connection to the account is automatically released without waiting for the lapse of the standby time, so that power consumption for unnecessary maintenance of the connection state to the account can be reduced.

The display controller 26 may also shorten the standby time when the switch SW of the drive device M of the moving object 2 is turned off by the time when the standby time has elapsed since the output of the target content to the target display device 13T was stopped. Note that the display controller 26 can know based on information from the vehicle control device 18 that the drive device of the moving object 2 is turned off.

When the switch SW of the drive device M of the moving object 2 is turned off, it is generally considered that the target user PT who has left the seat after starting viewing of a content is unlikely to return to the moving object again. According to the above configuration, the standby time is shortened when the switch SW of the drive device M of the moving object 2 is turned off, so that it is possible to prevent the connection state to the account from being maintained for an unnecessarily long time, thereby preventing unnecessary power consumption.

### 1.4 Operation of Content Output Device

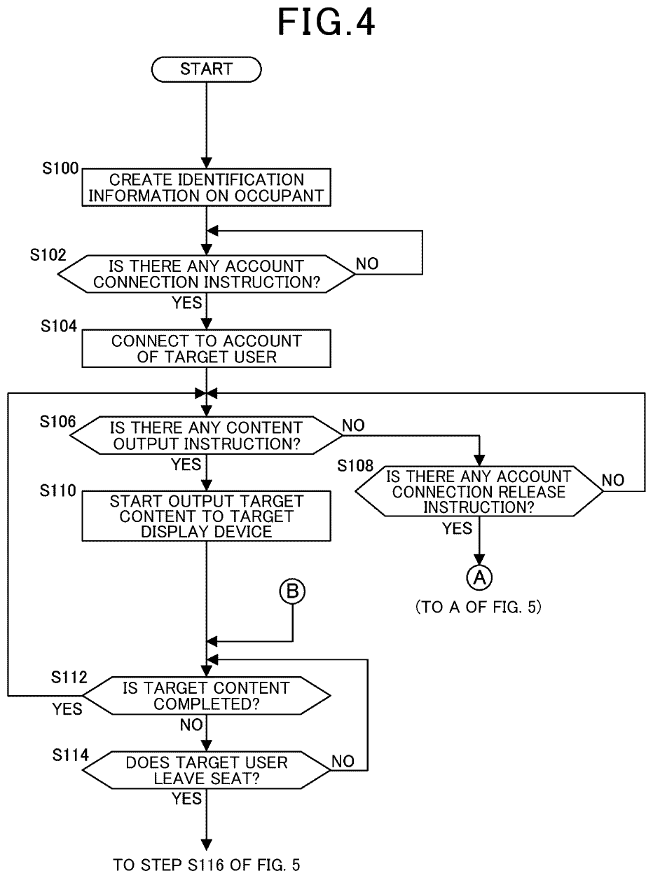

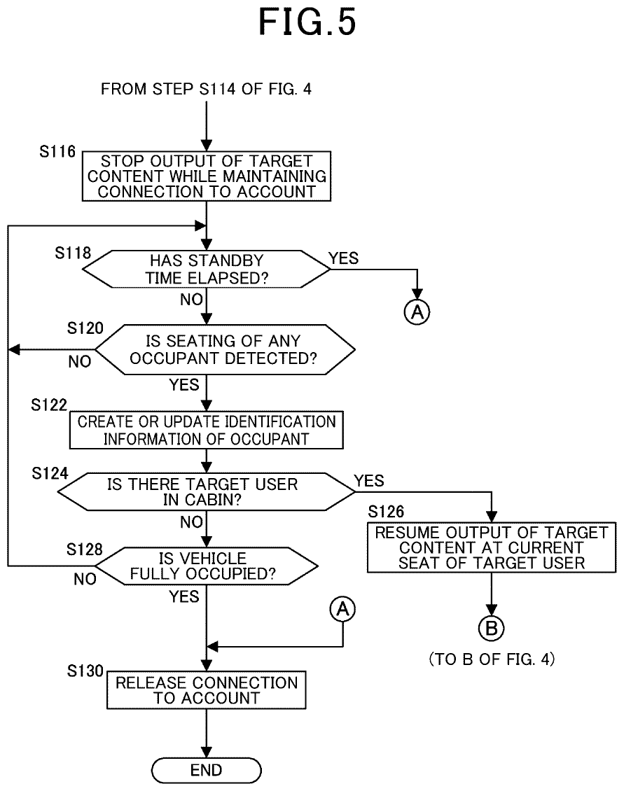

Next, the operation of the content output device 1 will be described. FIGS. 4 and 5 are flow diagrams showing the procedure of a content output method to be executed by a processor 20 which is a computer of the content output device 1. The processing starting from FIG. 4 begins when the moving object 2 is powered on and respective devices which are installed in the moving object 2 and include the content output device 1 are powered on, and thereafter is repeatedly executed until the moving object 2 is powered off.

Referring to FIG. 4, when the processing starts, the identification unit 25 of the content output device 1 identifies occupants P which currently get in the moving object 2, create identification information 24 for each occupant, and stores the created identification information 24 in the memory 21 (S100). Thereafter, the identification unit 25 detects leaving any seat 12 and seating in any seat 12 in the cabin 10 of the moving object 2, and a person getting in the moving object 2 (i.e., an increase in the number of occupants), identifies the occupants, and creates or updates the identification information 24 for that occupants.

Next, the display controller 26 of the content output device 1 determines whether there is any instruction of account connection via a display device 13 for one seat 12 from one occupant P seated in the one seat 12 (S102). When no instruction of account connection via a display device 13 is not issued from any occupant P seated in any seat 12 (S102, NO), the display controller 26 returns to step S102 and repeats the processing to wait for an instruction for account connection to be input by an occupant P on any seat 12.

On the other hand, when an instruction for account connection is issued from one occupant P seated in any one seat 12 via a display device 13 for the one seat 12 (S102, YES), in accordance with the account connection instruction, the connection is made to the account of the one occupant P which is input at the time of the instruction (S104). As described above, “connection is made to an account” means logging in to the account on the website of the content providing service.

In the following description, one occupant P who inputs an account connection instruction is referred to as a target user PT, and one seat 12 in which the target user PT is seated when the account connection instruction is input is referred to as a target seat 12T.

Next, the display controller 26 determines whether a content output instruction is input from the target user PT via the display device 13 of the target seat 12T (S106). When no content output instruction is input (S106, NO), the display controller 26 determines whether an account connection release instruction is input from the target user PT via the display device 13 of the target seat 12T (S108). As described above, “account connection release” means logging off the account on the website of the content providing service.

When no account connection release instruction is input (S108, NO), the display controller 26 returns to step S106 to repeat the processing. On the other hand, when an account connection release instruction is input (S108, YES), the display controller 26 shifts the processing to step S130 in FIG. 5 to release the account connection (S130), and ends this processing.

On the other hand, when a content output instruction is input in step S106 (S106, YES), the display controller 26 sets the content designated in the content output instruction as the target content while identifying the display device 13 of the target seat 12T as the target display device 13T, and starts outputting the target content on the target display device 13T (S110).

Next, the display controller 26 determines whether the output of the target content has been completed on the target display device 13T (S112). When the output of the target content has been completed (S112, YES), the display controller 26 returns to step S106 to repeat the processing.

On the other hand, when the output of the target content has not been completed (S112, NO), the display controller 26 determines whether the target user PT has left the target seat 12T (S114). Specifically, the display controller 26 determines whether a notification indicating that the target user PT has left the target seat 12T has been received from the identification unit 25.

When the target user PT has not left the seat (S114, NO), the display controller 26 returns to step S112 to repeat the processing.

On the other hand, when the target user PT has left the target seat 12T (S114, YES), the display controller 26 stops the output of the target content on the target display device 13T while maintaining the connection state to the account connected in step S100 (S116 in FIG. 5).

Next, the display controller 26 determines whether a predetermined standby time has elapsed since the output of the target content was stopped in step S116 (S118). When the standby time has elapsed (S118, YES), the processing is shifted to step S130 to release the account connection and terminate the processing. At that time, the display controller 26 may instruct the identification unit 25 to delete the identification information 24 for the target user PT from the memory 21.

On the other hand, when the standby time has not elapsed (S118, NO), the identification unit 25 determines whether seating of any occupant P (i.e., a motion or action in which any occupant P sits on any seat 12) in the cabin 10 of the moving object 2 is detected (S120).

When seating of any occupant P is not detected (S120, NO), the display controller 26 returns to step S118 to repeat the processing.

On the other hand, when seating of some occupant P is detected (S120, YES), the identification unit 25 creates or updates the identification information 24 for the seated occupant P (S122). Then, the display controller 26 determines based on the identification information 24 of all the occupants P whether the target user PT is present in the cabin 10 (S124).

When the target user PT is present in the cabin 10 (S124, YES), the display controller 26 identifies, as the target display device 13T, the display device of the seat 12 in which the target user PT is currently seated, and resumes the output of the target content of which the output has been stopped in step S116 on the target display device 13T (S126). Thereafter, the display controller 26 returns to step S112 to repeat the processing.

On the other hand, when the target user PT is not present in the cabin 10 in step S124 (S124, NO), the display controller 26 determines, based on the information from the identification unit 25, whether the cabin 10 of the moving object 2 has been fully occupied (S128). When the cabin 10 of the moving object 2 has not been fully occupied (S128, NO), the display controller 26 returns to step S118 to repeat the processing.

On the other hand, when the cabin 10 of the moving object 2 has been fully occupied (S128, YES), the display controller 26 releases the account connection performed in step S104 (S130), and terminates this processing. At that time, the display controller 26 may instruct the identification unit 25 to delete the identification information 24 on the target user PT from the memory 21.

Here, in FIGS. 4 and 5, the processing from step S102 to step S112 and the processing from step S16, step S118, and step S124 to step S130 correspond to a display control step in the present disclosure. Furthermore, steps S100, S114, S120, and S122 correspond to an identification step in the present disclosure.

### 2. Other Embodiments

In the above-described embodiment, the identification unit 25 detects the seating and leaving of the occupant P in and from each seat 12 by using the seating sensor 15 provided for each seat 12, but the seating and leaving may be also detected from an image of the interior of the cabin 10 acquired by the interior camera 16.

The present invention is not limited to the configuration of the above-described embodiment, and can be embodied in various forms without departing from the gist of the present invention.

### 3. Configuration Supported by Foregoing Embodiment

The above-described embodiment supports the following configurations.

(Configuration 1) A content output device includes a display controller for controlling output of a content to a display device provided for each of seats of a moving object, and an identification unit for identifying each of occupants seated in the seats of the moving object, wherein the display controller is adapted to: in accordance with a content output instruction from one occupant seated in one seat, connect to an account of the one occupant, the account being related to content viewing, and output a content to be provided to the account to one display device that is the display device for the one seat; and stop the output of the content to the display device for the one seat while maintaining the connection to the account when the one occupant leaves the one seat.

According to the content output device of configuration 1, in a case where a content provided to an account of a user (occupant) is output in a moving object, when the user leaves a seat, the output of the content is stopped and a connection state to the account is maintained, so that it is possible to simplify a user operation related to resumption of the output of the content when the user returns to his/her original seat while preventing the content from being viewed by others, so that it is possible to improve convenience.

(Configuration 2) In the content output device described in the configuration 1, the display controller releases the connection to the account of the one occupant when a predetermined standby time has elapsed after the output of the content to the display device for the one seat is stopped.

According to the content output device of the configuration 2, when a seat-leaving time of the user (the one occupant) gets longer and exceeds the standby time, the display controller releases the connection to the account, so that the user does not need to return to the moving object and perform an operation of releasing the connection to the account, so that convenience for users is further improved.

(Configuration 3) In the content output device described in the configuration 3, the moving object is a vehicle, and the standby time is determined based on a location where the moving object is stopped when the one occupant leaves the one seat.

According to the content output device of the configuration 3, it is possible to set a standby time so as to match a general time from the occupant getting off until the occupant getting in again, which may vary according to the stop location of the moving object, so that it is possible to further improve convenience for users.

(Configuration 4) In the content output device described in the configuration 2 or 3, when seating of an occupant in the moving object is detected during the standby time after the output of the content to the display device for the one seat is stopped, the display controller determines whether the one occupant is seated in the moving object, and when the one occupant is seated in the moving object, the display controller resumes the output of the content which has been stopped to a display device for a seat in which the one occupant is seated.

According to the content output device of the configuration 4, when a user (one occupant) who has started viewing of a content provided to his/her account on one seat in the moving object leaves his/her seat and then sits down again in the moving object, the user can resume viewing of the content on a seat in which the user is seated again irrespective of whether the seat is his/her original seat (the one seat) or a different seat. As a result, according to the content output device of the configuration 4, it is possible to further improve convenience for users.

(Configuration 5) In the content output device described in any one of the configurations 2 to 4, when seating of an occupant in the moving object is detected during the standby time after the output of the content to the display device for the one seat is stopped, the display controller determines whether the one occupant is seated in the moving object, and when the one occupant is not seated in the moving object, the display controller maintains an output stop state of the content.

According to the content output device of the configuration 5, even when one occupant who has started viewing of a content provided to his/her account on one seat in the moving object leaves the one seat and then another occupant is seated in the one seat, the output stop state of the output of the content is maintained, so that it is possible to appropriately prevent the other occupant from viewing the content.

(Configuration 6) In the content output device described in any one of the configurations 2 to 5, when the moving object is fully occupied during the standby time after the output of the content to the display device for the one seat is stopped, the display controller determines whether the one occupant is present in the moving object, and when the one occupant is not present in the moving object, the display controller releases connection to the account of the one occupant.

According to the content output device of the configuration 6, when a user (one occupant) who has started viewing of a content using an account is unlikely to get in the moving object again like such a case that the moving object is fully occupied after the user leaves the seat, the connection to the account is automatically released without lapse of the standby time, so that it is possible to reduce power to be consumed for unnecessary maintenance of the account connection state.

(Configuration 7) In the content output device described in any one of the configurations 2 to 6, the display controller shortens the standby time when a switch of a drive device of the moving object is turned off during the standby time after the output of the content to the display device for the one seat is stopped.

When the switch of the drive device of the moving object is turned off, it is generally considered that an occupant who leaves a seat after starting viewing of a content is unlikely to return to the moving object again. According to the content output device of the configuration 7, the standby time is shortened when the switch of the drive device of the moving object is turned off, so that it is possible to prevent an unnecessary consumption of power caused by maintenance of an account connection state for an unnecessarily long time.

(Configuration 8) A content output method to be executed by a computer of a content output device for outputting a content to a display device provided for each of seats of a moving object, includes: a display control step of controlling output of a content to the display device provided for each of the seats, and an identification step of identifying each of occupants seated in the seats of the moving object, wherein the display control step includes: in accordance with a content output instruction from one occupant seated in one seat, connecting an account of the one occupant, the account being related to content viewing, and outputting a content to be provided to the account to one display device that is the display device for the one seat; and stopping the output of the content to the display device for the one seat while maintaining the connection to the account when the one occupant leaves the one seat.

According to the content output method of the configuration 8, in a case where a content to be provided to an account of a user (occupant) is output in a moving object, the output of the content is stopped and an account connection state is maintained when the user leaves his/her seat, which makes it possible to simplify a user operation of resuming the output of the content when the user returns to his/her original seat while preventing the content from being viewed by others, thereby improving convenience.

### Reference Signs List

1 . . . content output device; 2 . . . moving object; 3 . . . communication network; 4 . . . content server; 4a . . . first content server; 4b . . . second content server; 5 . . . game server; 10 . . . cabin; 11 . . . steering wheel; 12 . . . seat; 12a . . . driver's seat; 12b . . . assistant driver's seat; 12c . . . second-row left seat; 12d . . . second-row right seat; 12e . . . third-row left seat; 12f . . . third-row right seat; 12T . . . target seat; 13, 13a, 13b, 13c, 13d, 13e, 13f, 13g . . . display device; 13T . . . target display device; 14, 14L, 14R, 14La, 14Lb, 14Lc, 14Ld, 14Le, 14Lf, 14Ra, 14Rb, 14Rc, 14Rd, 14Re, 14Rf . . . speaker; 15, 15a, 15b, 15c, 15d, 15e, 15f . . . seating sensor; 16 . . . interior camera; 17 . . . media reader; 18 . . . vehicle control device; 19 . . . navigation device; 20 . . . processor; 21 . . . memory; 22 . . . communication device; 23 . . . program; 24 . . . identification information; 25 . . . identification unit; 26 . . . display controller; M . . . drive device; P . . . occupant; PT . . . target user; SW . . . switch

What is claimed is:

1. A content output device comprising:
a display controller for controlling output of a content to a display device provided for each of seats of a moving object; and
an identification unit for identifying each of occupants seated in the seats of the moving object, wherein the display controller is adapted to:
in accordance with a content output instruction from one occupant seated in one seat, connect to an account of the one occupant, the account being related to content viewing, and output a content to be provided to the account to one display device that is the display device for the one seat; and
stop the output of the content to the display device for the one seat while maintaining the connection to the account when the one occupant leaves the one seat.

2. The content output device according to claim 1, wherein the display controller releases the connection to the account of the one occupant when a predetermined standby time has elapsed after the output of the content to the display device for the one seat is stopped.

3. The content output device according to claim 2, wherein the moving object is a vehicle, and the standby time is determined based on a location where the moving object is stopped when the one occupant leaves the one seat.

4. The content output device according to claim 2, wherein when seating of an occupant in the moving object is detected during the standby time after the output of the content to the display device for the one seat is stopped, the display controller determines whether the one occupant is seated in the moving object, and when the one occupant is seated in the moving object, the display controller resumes the output of the content which has been stopped to a display device for a seat in which the one occupant is seated.

5. The content output device according to claim 2, wherein when seating of an occupant in the moving object is detected during the standby time after the output of the content to the display device for the one seat is stopped, the display controller determines whether the one occupant is seated in the moving object, and when the one occupant is not seated in the moving object, the display controller maintains an output stop state of the content.

6. The content output device according to claim 2, wherein when the moving object is fully occupied during the standby time after the output of the content to the display device for the one seat is stopped, the display controller determines whether the one occupant is present in the moving object, and when the one occupant is not present in the moving object, the display controller releases the connection to the account of the one occupant.

7. The content output device according to claim 2, wherein the display controller shortens the standby time when a switch of a drive device of the moving object is turned off during the standby time after the output of the content to the display device for the one seat is stopped.

8. A content output method to be executed by a computer of a content output device for outputting a content to a display device provided for each of seats of a moving object, comprising:
a display control step of controlling output of a content to the display device provided for each of the seats; and
an identification step of identifying each of occupants seated in the seats of the moving object, wherein the display control step comprises:
in accordance with a content output instruction from one occupant seated in one seat, connecting an account of the one occupant, the account being related to content viewing, and outputting a content to be provided to the account to one display device that is the display device for the one seat; and
stopping the output of the content to the display device for the one seat while maintaining the connection to the account when the one occupant leaves the one seat.
